(19) United States
(12) Patent Application Publication
(10) Pub. No.: US 2024/0233568 A1
(43) Pub. Date: Jul. 11, 2024

(54) Method and System for People Skills Profiling

(71) Applicant: ALEAS Technologies Kft., Budapest (HU)

(72) Inventors: Zsadany Vecsey, Budapest (HU); Zoltan A. Papp, Spicewood, TX (US)

(21) Appl. No.: 18/095,653

(22) Filed: Jan. 11, 2023

(51) Int. Cl. G09B 7/02; G09B 7/077

(52) U.S. Cl. CPC G09B 7/02; G09B 7/077

(57) ABSTRACT

Described herein are methods and a system that create competency assessments and insights as to skills-profiles of an individual based on human machine interaction on a data source that includes movies, video games, and vehicles. The choices that the individual makes during the interaction are translated to particular options in a flow. The options are processed as to desirable skill sets of the flow. Competency level assessment and skills profiles based on the processing of the options is performed.

### BACKGROUND OF THE INVENTION

### Field of the Invention

The present invention relates providing skills-profiles for individuals based on media interaction of individuals. More specifically, embodiments of the invention provide for creating competency assessments and insights as to skills-profiles based on various inputs and data streams provided by individuals.

### Description of the Related Art

Determining particular skills sets and profiles for individuals can be an involved process. Accurately gauging and assessing abilities of individuals can be lengthy and complicated, involving experts working with the individuals. Furthermore, standardizing skills sets, and profiles is needed to gauge relevance of individuals to others and to desired metrics and values (e.g., competency).

It is desirable to provide systems and processes for individuals to provide inputs that are used to create competency assessments and skills profiles specific to such individuals.

### SUMMARY OF THE INVENTION

A computer-implementable method, system and computer-readable storage medium for creating competency assessments and insights as to skills-profiles comprising providing multiple choices at a data source for an individual; determining choices that are made as to possible options in a flow; processing the options based on desirable skill sets of the flow; and assessing competency level and skills profiles based on the processing of the options.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 illustrates a system as implemented in the present invention;

FIG. 2 illustrates a profile ratings categories;

FIG. 3 illustrates a configurable decision model;

FIG. 4 illustrates a flow process;

FIG. 5 illustrates set of flow promoting skills;

FIG. 6 is a generalized flowchart for creating competency assessments and insights as to skills-profiles; and

FIG. 7 is an illustration of a computing system as implemented in the system and method of the present invention.

### DETAILED DESCRIPTION

Various implementations provide for system and methods for people skills-profiling based on data generated by interactive multimedia products or other digital interactions using branching-tree modeled decision structures.

Certain implementations provide for insights based on movie and videogame interactions, and transforming data streams generated by individual decision making into people skills profiles and assessments, such as data collected from vehicles/devices based on individual habits and patterns.

Implementations described herein provide for improvement of individual and group flow. Flow, also known as the “flow state,” is a psychological concept that refers to a state of optimal experience or complete absorption in an activity. When an individual or person is in a state of flow, they are fully immersed in what they are doing and are able to fully engage with the present moment. This can lead to a feeling of enjoyment, happiness, and a sense of accomplishment.

There are a number of benefits to experiencing flow in an individual's daily life. The following are examples of such benefits. Increased productivity: when a person is in a state of flow, they can be more focused and motivated, which can lead to increased productivity. Improved performance: flow can also lead to improved performance for various tasks and activities, allowing the individual to fully engage with what they are doing. Increased well-being: the state of flow can also contribute to an overall sense of well-being and happiness, as often leads to a feeling of enjoyment and fulfillment. Greater creativity: flow can also lead to increased creativity, allowing the individual to fully immerse themselves in their work and come up with new ideas and solutions.

In order to experience flow, it is important to find activities that are challenging but not overwhelming, and to fully engage with those activities. This can involve setting clear goals, focusing on the present moment, and letting go of distractions.

Group flow, also known as collective flow, is a state of optimal experience or complete absorption that occurs when a group of individuals are working together towards a common goal and are fully engaged in the present moment. Group flow can be characterized by a sense of unity, cooperation, and effortlessness, as well as a feeling of enjoyment and accomplishment.

To experience group flow, the group works towards a clear and achievable goal, and each member/individual feels a sense of ownership and responsibility for the group's success. The group should have good communication and teamwork, and for there should be a sense of trust and support among the members.

Group flow can lead to increased productivity and improved performance, as well as a sense of satisfaction and fulfillment for the group members. It is often experienced in activities that involve collaboration and cooperation, such as sports, music, and team-based projects.

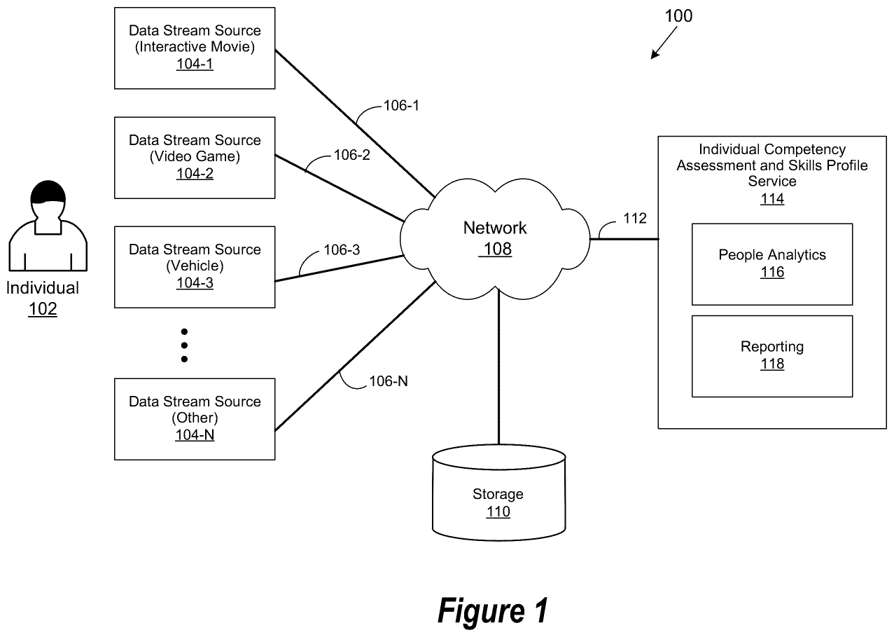

FIG. 1 shows a system 100 for competency assessments and skills profiles for individuals. A person or an individual 102 interacts with one or more data stream sources 104. Implementations provide for data stream sources 104 to be configured as devices, such as information handling systems (e.g., laptop computers, cellular phones, servers, etc.), interactive websites, vehicles, etc. In general, data stream sources 104 are configured to interact and receive specific inputs from individual 102.

An example of data stream source 104, includes an interactive movie (video) 104-1. The interaction of individual 102 with interactive movie 104-1 can include prompts during certain scenes for the individual 102 to make a choice. The choices that are made by individual 102 are entered as data 106-1. Another example of data stream sources 104, includes video game 104-2. Interaction of individual 102 with video game 104-2 can include actions taken by individual 102 during video game play. The particular actions taken by the individual 102 are entered as data 106-2. Another example of data streams 104, includes a vehicle 104-3. The individual 102 during operation of vehicle 104-3 performs particular driving actions in a driving environment. Such driving actions by individual 102 are entered as data 106-3.

It is contemplated that other data sources can be implemented, such as data stream source (other) 104-N. Such data stream source (other) 104-N involves interactions/actions taken by individual 102, where such interactions/actions are recorded as data per a decision made by the individual 102. The decision is one of multiple decisions that can be made by individual 102. Therefore, there is a human (individual 102) and machine (data stream source 104) interaction that is performed, and collection of choices (decisions) made by individual 102, and provided by data stream source(s) 104, as data 106.

Implementations further provide for the system 100 to include a network 108. The network 108 can include one or more wired and wireless networks, including the Internet. The data sources 104 are connected to network 108, and through network 108, are connected to other elements of the system 100.

In various implementations, the system 100 includes storage 100 that is connected to network 108. Storage 100 can include various physical data stores, cloud storage, etc. Certain implementations provide for data 106 to be stored in storage 110 to be accessed by other elements of the system 100.

Data 106 can be passed as data 112 from network 108. In certain implementations, stored data 106 in storage 110, is passed as data 112. In particular, data 112 is received by an individual competency and skills profile service 114. The individual competency and skills profile service 114 can be configured as one or more of the information handling systems (e.g., server computers, etc.), or as cloud computing. The individual competency and skills profile service 114 further can provide an accessible website or interface.

Implementations provide for the individual competency and skills profile service 114 to include a people analytics component 116. The people analytics component 116 analyzes data stream 112 based on human machine interaction as described above, and transforms the choices made by individual 102 into numeric skill values. Particular processes performed by the people analytics component 116 are described herein.

Implementations further provide for the people analytics component 116 to including a reporting component 118. The reporting component can be configured to generate assessments based on skill values as further described herein. Feedback is provided as to behavior patterns as represented by choices made by individual 102.

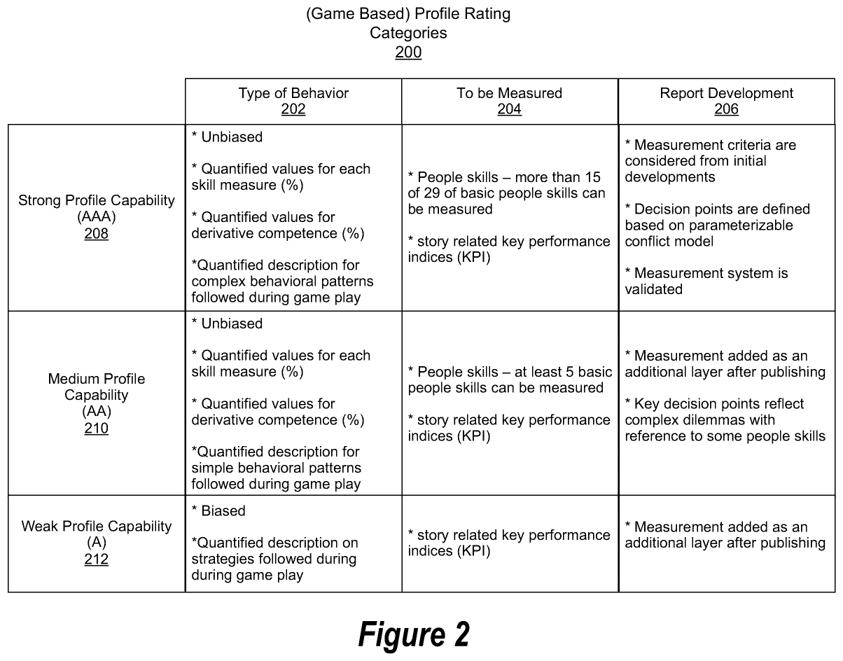

FIG. 2 shows profile ratings categories 200. Implementations provide for the people analytics component 116 to provide processes using profile ratings categories 200. Implementations provide for the profile ratings categories 200 to be game based, where interactions of user 102 is with data source 104, such video game 104-2, or can be interactions with an interactive movie 104-1.

The profile ratings categories 200 include headings of type of behavior 202, skills to be measured 204, and report development 206. Categorizing is based on certain profile qualities. In particular, in this example, strong profile capability 208, medium profile capability 210, and weak profile capability 212. Each of the profile qualities 208, 210, and 212 are defined by the headings 202, 204, and 206. For example, strong profile capability 208 includes particular types of (individual 102) behavior 202, particular metrics to be measured 204, and report to be developed 206 for the individual 102. Likewise, 208, medium profile capability 210 and weak profile capability 212 are similarly defined by the headings 202, 204, and 206.

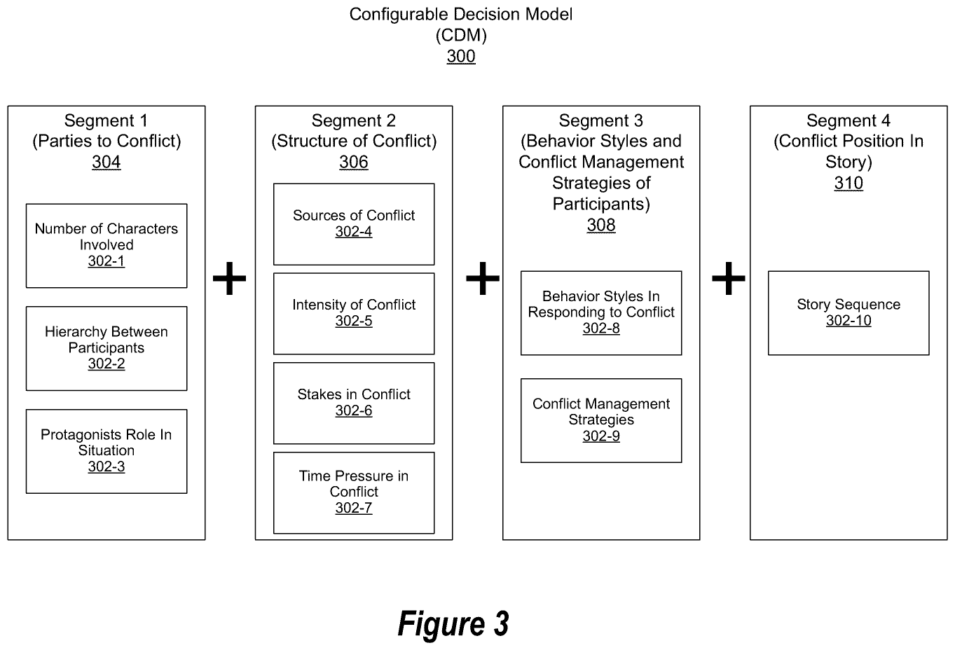

FIG. 3 shows configurable decision model (CDM) 300. Implementations provide for the people analytics component 116 to implement CDM 300. In this example, the CDM 300 implements ten factors 302 that for example relate to a theme or story. In general, factors 302 define or describe a conflict situation.

For example, the ten factors can include “number of characters involved” 302-1, “hierarchy between participants” 302-2, “protagonists' role in situation” 302-3, “sources of conflict” 302-4, “intensity of conflict” 302-5, “stakes in conflict” 302-6, “time pressure in conflict” 302-7, “behavior styles in responding to conflict” 302-8, “conflict management strategies” 302-9, and “story sequence” 302-10. Each factor 302 can have a specific and predefined value.

The CDM 300 is summarized by the ten factors 302 and are grouped in segments. In this example the ten factors 302 are grouped into four segments. “Number of characters”involved” 302-1, “hierarchy between participants” 302-2, and “protagonists' role in situation” 302-3 are grouped into “parties to conflict” segment 1 310. “Sources of conflict” 302-4, “intensity of conflict” 302-5, “stakes in conflict” 302-6, and “time pressure in conflict” 302-7 are grouped into segment 2 “structure of conflict” 306. “Behavior styles in responding to conflict” 302-8, and “conflict management strategies” 302-9 are grouped into segment 3 “behavior styles and conflict management strategies of participants” 308. “Story sequence” 302-10 is grouped into segment 4 “conflict position in story” 310. In various implementations, value of factors 302 define skills that can be measured at a particular decision point (complex decision point described below).

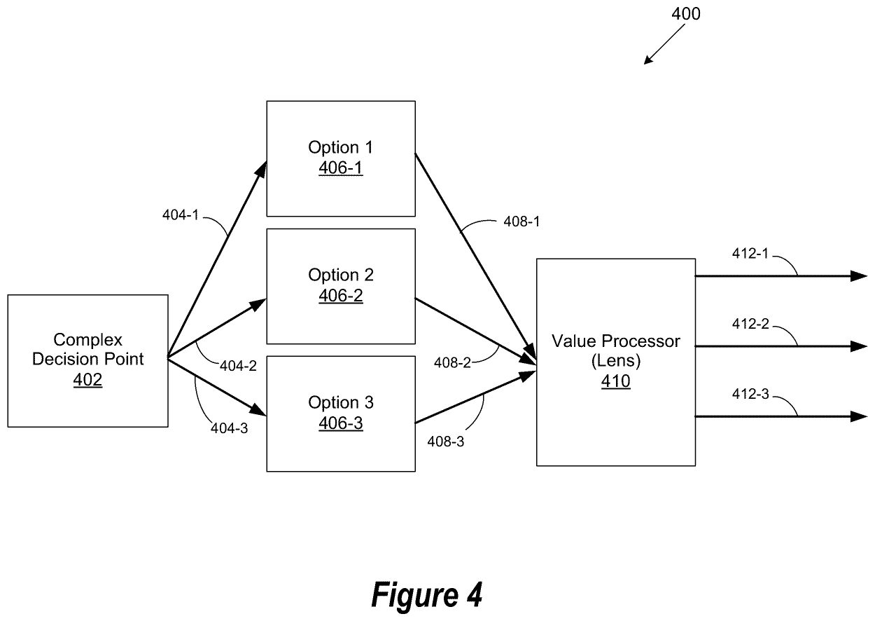

FIG. 4 shows a flow process 400. The flow process 400 is considered as a value system operating in a social interactive environment. Decisions of individual 102 are evaluated to determine which skills are used to make such decisions.

An individual 102 is presented with a complex decision point 402. The complex decision point 402 presents a dilemma to individual 102, where the individual 102 is asked to make a choice. For example, the complex decision point 402 may be designed to be based on leadership promoting assessment, based on certain skills or people skills as described below.

The choices made by individual 102 are provided as choices 404. In this example, there are three choices available to the individual 102, represented as choice 404-1, 404-2, and 404-3. The choices 404 are sent to respective options 406. Choice 404-1 to option 1 406-1. Choice 404-2 to option 2 406-2. Choice 404-3 to option 3 406-3.

The options 406 provide input 408 to value processor (lens) 410. Option 1 406-1 providing input 408-1. Option 1 406-2 providing input 408-2. Option 3 406-3 providing input 408-3.

The value processor (lens) 410 is configured to perform assessment on the inputs 408 provided by options 406. In particular, value processor (lens) 410 ranks options 406 as to a flow promoting potential. The value processor (lens) 410 determines for a particular flow, to what extent does the option 406 support the flow. The flow being a concept that describes when individual 102 is absorbed in a challenging but attainable task. As discussed, flow, also known as the “flow state,” is a psychological concept that refers to a state of optimal experience or complete absorption in an activity. When an individual is in a state of flow, they are fully immersed in what they are doing and are able to fully engage with the present moment. This can lead to a feeling of enjoyment, happiness, and a sense of accomplishment.

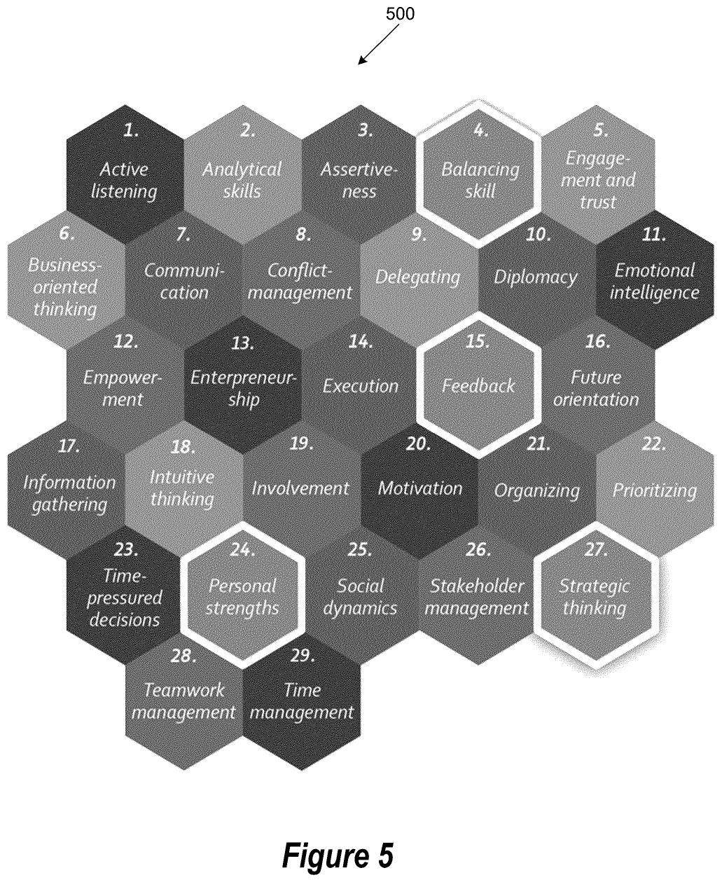

The value processor (lens) 410 provides assessed outputs 412 as to the options 406. Determining as to a flow promoting option 406 relates to the use of particular skills. For example, as to output 412-1, if option 1 406-1 supports the flow promoting idea, the individual 102 demonstrates use of related skills, as further described in FIG. 5. For skills A, B, and C, the variables of such skills are true. As to output 412-2, if option 2 406-2 does not support the flow promoting idea, the individual 102 does not use the related skills. For skills A, B, and C, the variables of such skills are false. As to output 412-3, if option 3 406-3 does not support the flow promoting idea, the individual 102 does not use the related skills. For skills A, B, and C, the variables of such skills are false

FIG. 5 shows a set 500 of skills. The set of skills in this example are 29 skills that relate to flow. Volatility, uncertainty, complexity, and ambiguity or VUCA, as well as flow (e.g., group flow) can be measure with the 29 skills as described herein through “derivative” or “secondary” analytics. The elements of VUCA serve to enhance strategic significance of VUCA foresight and insight as well as behavior of groups and individuals. The elements address systemic and behavioral failure which can characteristic of group failure. Volatility (V) is the nature and dynamics of change, and the nature and speed of change forces and change catalysts. Uncertainty (V) is the lack of predictability, the prospects for surprise, and the sense of awareness and understanding of issues and events. Complexity (C) is the multiplex of forces, the confounding of issues, no cause-and-effect chain and confusion that surrounds organization. Ambiguity (A) is the haziness of reality, the potential for misreads, and the mixed meanings of conditions; cause-and-effect confusion.

In various implementations, the 29 skills are the skills used in flow process 400 described in FIG. 4. For example, in an interactive movie implementation, the complex decision point 402 is subject to scoring skills. This can be assessed by determining which of the 29 skills are needed to resolve a conflict represented by the given decision point 402. These are considered as resonating skills. A determination is made as which decision-alternative best meets the basic principle (e.g., options 406).

In each case, when the user chose the “most preferred” answer, the resonating skills “earn a point” for the decision (the resonating skill's variable was set “true”). For each skill, the maximum number of points that can be earn can be standardized at 100%. This allows for determining the percentage score on each skill.

The set 500 of 29 skills can be considered a modular design, meaning that each skill can be considered as an elementary “building block” and can be combined or regrouped with other skills to create more complicated competency categories. Such regrouping allows for the determining of competencies such as “Agility” or “Learning Fast.” This “building block” approach (i.e., combining the skills along with any other categorization) can allow for the measurement of multi-dimensional capabilities.

For example, as to capability of competence “Learning Fast,” which is to manage tasks in a volatile and uncertain environment, basic skills of the 29 skills are combined.

“Learning Fast” can be defined is an open and growth-oriented mindset essential to learning quickly and capitalizing on successes and failures. Individuals who learn fast allow themselves to be open to new ideas and promptly synthesize the new ideas from the information they have gathered. Fast learners also know that they can adapt ideas from any team member and will engage everyone to provide input that might be useful.

Selection from the 29 skills is performed for possessing the given competence. “Learning Fast” enables an open-minded stance and a rapid synthesis of successes and failures. The critical skills measured here include business-oriented, strategic, and intuitive thinking. These are represented by the skills “business-oriented thinking,” “strategic thinking,” and “intuitive thinking” as elements of the primary 29 skills. In certain implementations, weighting of the skills is performed.

The skills are related to attributes of people (e.g., individual 102). In this example, active listening 1 is a skill as to a way of responding to another person that improves mutual understanding. This is a method of listening that involves understanding the content of a message as well as the intent of the sender and the circumstances under which the message is given. Active listening is a structured form of listening and responding that focuses the attention on the speaker. The listener does not have to agree with the speaker—he or she must simply state what he or she thinks the speaker said.

Analytical skill 2 is a skill as to the readiness to visualize, articulate, and solve complex problems and concepts and make decisions that are sensible based on the available information. Such skill includes the demonstration of the ability to apply logical thinking to gathering and analyzing information, designing and testing solutions to problems, and formulating plans.

Assertiveness 3 is the skill to readily express emotions and needs without violating the rights of others and without being aggressive. Assertiveness is the behavior that enables you to act in your own best interests, to stand up for yourself without undue anxiety, to express your honest feelings comfortably, or to exercise your own rights without denying the rights of others.

Balancing Skill 4 is the readiness to maintain the same importance between things, considering them in the same way. Effective leadership is about balance. A balance between challenges and skills is necessary for flow. It is easier to become completely involved in a task if we believe it is doable. If it appears to be beyond our capacity, we tend to respond to it by feeling anxious; if the task is too easy, we get bored. In either case attention shifts from what needs to be accomplished—the anxious person is distracted by worries about the outcome, while the bored one starts searching for other things to do. The ideal condition can be expressed by the simple formula: Flow occurs when both challenges and skills are high and equal to each other.

Building engagement and trust 5 is the readiness to create trust and a positive, fulfilling, work-related state of mind that is characterized by dedication. Dedication refers to being strongly involved in one's work and experiencing a sense of significance, enthusiasm, and challenge. Building someone's (the colleagues, the community) confidence in or reliance on some quality or attribute of a person or a thing, or the truth in a statement.

Business-oriented thinking 6 is the readiness to manage situations and solve problems in order to create added value to the company and in the end, create value for the shareholders/stakeholders. To be successful in business development you need to manage the opportunities and threats of the corporate environment and to recognize organizational weaknesses to avoid, and strengths to build upon.

Communication skills 7 are the set of skills that enable a person to convey information so that it is received and understood. Communication skills refer to the repertoire of interpersonal behavior.

Conflict-management 8 is the practice of identifying and handling conflicts in a sensible, fair, and efficient manner. Conflict management is the principle that all conflicts cannot necessarily be resolved, but learning how to manage conflicts can decrease the odds of nonproductive escalation.

Delegation 9 is the readiness to confer functions or powers on another person so he or she can act on behalf of the manager. Delegation empowers a subordinate to make decisions (i.e., a shift of decision-making authority from one organizational level to a lower one).

Diplomacy 10 is the readiness to consider varying interests and values of the other parties involved in the negotiation, treating those differences with respect and dealing with people in a tactful manner.

Emotional intelligence 11 is the capacity and readiness to understand, express and regulate emotions in oneself and in others.

Empowerment 12 is a skill of sharing information, rewards, and power with employees so that they can take initiative and make decisions to solve problems and improve service and performance.

Entrepreneurship (Risk-taking) 13 is a capacity and willingness to undertake the conception, organization, and management of a productive venture with all attendant risks while seeking profit as a reward. The entrepreneurial spirit is characterized by innovation and risk-taking, and an essential component to succeed in an ever-changing and more competitive global marketplace.

Execution 14 is the act of performing, the completion of managerial tasks (execution of a plan, a task, etc.), and the readiness of doing something successfully. Managing the business aligned with the common values. Executing strategic goals is by far the greatest challenge in business today.

Feedback 15 relates to providing information to others regarding their performance that they can also act on. Feedback is shared in a manner that is understandable and perceived by them as being provided in a highly respectful manner. As an organization seeks to improve its performance, feedback helps it to make the required adjustments. Feedback can be immediate.

Future orientation 16 is the readiness to think in long terms. This is the skill of “forward-looking.”

Information gathering 17 is the readiness to collect adequate information to perform the next step based on this information. Managers should know what information to gather, where to find it, how to collect it, and ultimately how to process the collected information.

Intuitive thinking 18 is a way of thinking that does not use rational processes such as facts and data. It is unfocused, nonlinear, sees many things at once, views the big picture and contains perspective. Good intuition comes from years of knowledge and experience that allow you to understand how people and the world works. Its strength is that it can produce a rapid result. It is acting on feelings or hunches. It can also be guided by emotions.

Involvement 19 is the readiness to participate in the activities of formal or informal teams/groups, all the way to the execution process.

Motivation 20 are skills that enable a person to become motivated and work toward achieving goals. This is the readiness to understand what causes a person to become motivated and stay that way. This skill helps assure people are the most productive that they can be.

Organizing 21 is the readiness to initiate, arrange and manage several elements into a purposeful structure. This is the ability to create throughout the organization a network of people who can help solve implementation problems as they occur. Good implementers customize this network to include individuals who can handle the special types of problems anticipated in the implementation of a particular strategy.

Prioritization 22 is the readiness to evaluate a group of items and ranking them in their order of importance or urgency.

Time-pressured decision-making 23 is decision-making under time pressure and a readiness that enables effective decision-making when limited time and inadequate information is available. This is the skill to decide authoritatively and to be consistent with one's decisions.

Personal strengths 24 is recognizing and applying personal strengths is the readiness to discover and to put to good use those personal strengths of others that are not immediately obvious. It is the realization that those strengths can potentially induce flow states in that other person and thus benefit the organization.

Social dynamics 25 is an awareness of the complexity of many situations and the social dynamics that govern them. This skill can be used to advance one's own interest—for the good or otherwise—and/or that of the organization.

Stakeholder management 26 is the ability to manage the business process, often involving a trade-off, so as to have a positive impact on the organizations' stakeholders, including that of society at large.

Strategic thinking 27 helps to set goals, to determine priorities, to review policy issues, and to perform long-term planning. Clear goals are necessary to reach the flow-state. For a person to become deeply involved in any activity it is essential that he or she knows precisely what tasks he or she must accomplish moment by moment.

Teamwork management 28 is the readiness to form, facilitate and monitor teamwork and teams.

Time management 29 is a readiness of systematic, priority-based structuring of time allocation and distribution among competing demands.

Implementations provide for the use of skills/variables matrix, where values of configurable decision model (CDM) 300 are assigned to each element of a skillset.

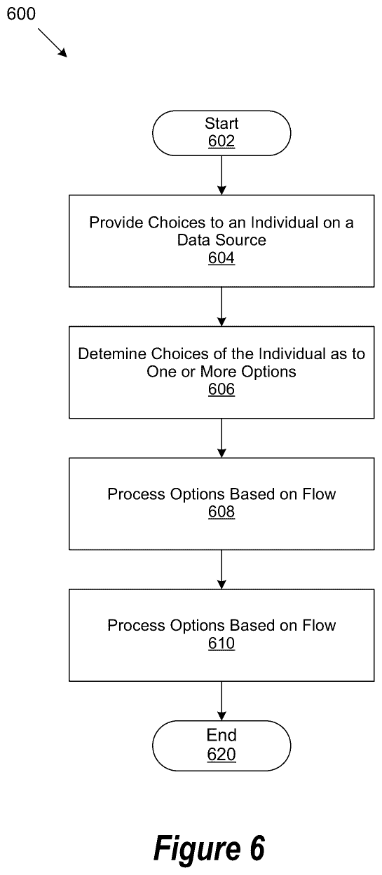

FIG. 6 shows a generalized flowchart for creating competency assessments and insights as to skills-profiles. The order in which the method is described is not intended to be construed as a limitation, and any number of the described method steps may be combined in any order to implement the method, or alternate method. Additionally, individual steps may be deleted from the method without departing from the spirit and scope of the subject matter described herein. Furthermore, the method may be implemented in any suitable hardware, software, firmware, or a combination thereof, without departing from the scope of the invention. For example, implementations provide for the system 100 to perform the process 600 and steps described herein.

At step 602, the process 600 starts. At step 604, multiple choices are provided to an individual 102 at an interactive data source 104, creating a human machine interaction. Examples of data sources 104 include movies, video games, device/vehicles, etc. The choices are provided as data 106 in data streams.

At step 606, determination is performed as to the choices as related to one or more options 406. Such options 406 are provided to value processor (lens) 410.

At step 608, the options 406 are processed based on a flow relating to particular skill sets that are desirable in the flow.

At step 610, assessment is performed as to competency level, and skills profiles provided of the individual based on the processed options. At step 620, the process 600 ends.

For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, gaming, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a microphone, keyboard, a video display, a mouse, etc. The information handling system may also include one or more buses operable to transmit communications between the various hardware components.

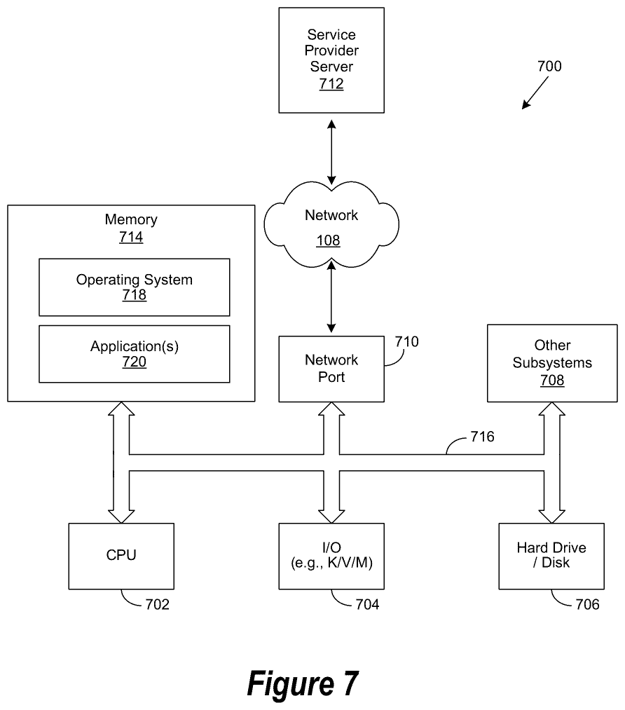

FIG. 7 is a generalized illustration of an information handling system (IHS) 700 that can be used to implement the system and method of the present invention. The information handing system (IHS) 700 can be a host to the peripheral devices described herein.

The information handling system (IHS) 700 includes a processor (e.g., central processor unit or “CPU”) 702, input/output (I/O) devices 704, such as a microphone, a keyboard, a video display or display device, a mouse, and associated controllers (e.g., K/V/M), a hard drive or disk storage 706, and various other subsystems 708.

In various embodiments, the information handling system (IHS) 700 also includes network port 710 operable to connect to the network 108, as described in FIG. 1, network 108 can include one or more wired and wireless networks, including the Internet. Network 108 is likewise accessible by a service provider server 712.

The information handling system (IHS) 700 likewise includes system memory 714, which is interconnected to the foregoing via one or more buses 716. System memory 714 can be implemented as hardware, firmware, software, or a combination of such. System memory 714 further includes an operating system (OS) 718, and one or more application(s) 720.

The present invention is well adapted to attain the advantages mentioned as well as others inherent therein. While the present invention has been depicted, described, and is defined by reference to particular embodiments of the invention, such references do not imply a limitation on the invention, and no such limitation is to be inferred. The invention is capable of considerable modification, alteration, and equivalents in form and function, as will occur to those ordinarily skilled in the pertinent arts. The depicted and described embodiments are examples only and are not exhaustive of the scope of the invention.

As will be appreciated by one skilled in the art, the present invention may be embodied as a method, system, or computer program product. Accordingly, embodiments of the invention may be implemented entirely in hardware, entirely in software (including firmware, resident software, micro-code, etc.) or in an embodiment combining software and hardware. These various embodiments may all generally be referred to herein as a “circuit,” “module,” or “system.” Furthermore, the present invention may take the form of a computer program product on a computer-usable storage medium having computer-usable program code embodied in the medium.

Any suitable computer usable or computer readable medium may be utilized. The computer-usable or computer-readable medium may be, for example, but not limited to, an electronic, magnetic, optical, electromagnetic, infrared, or semiconductor system, apparatus, or device. More specific examples (a non-exhaustive list) of the computer-readable medium would include the following: a portable computer diskette, a hard disk, a random-access memory (RAM), a read-only memory (ROM), an erasable programmable read-only memory (EPROM or Flash memory), a portable compact disc read-only memory (CD-ROM), an optical storage device, or a magnetic storage device. In the context of this document, a computer-usable or computer-readable medium may be any medium that can contain, store, communicate, or transport the program for use by or in connection with the instruction execution system, apparatus, or device.

Computer program code for carrying out operations of the present invention may be written in an object-oriented programming language such as Java, Smalltalk, C++ or the like. However, the computer program code for carrying out operations of the present invention may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network (LAN) or a wide area network (WAN), or the connection may be made to an external computer (for example, through the Internet using an Internet Service Provider).

Embodiments of the invention are described with reference to flowchart illustrations and/or step diagrams of methods, apparatus (systems) and computer program products according to embodiments of the invention. It will be understood that each step of the flowchart illustrations and/or step diagrams, and combinations of steps in the flowchart illustrations and/or block diagrams, can be implemented by computer program instructions. These computer program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram step or steps.

These computer program instructions may also be stored in a computer-readable memory that can direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

The present invention is well adapted to attain the advantages mentioned as well as others inherent therein. While the present invention has been depicted, described, and is defined by reference to particular embodiments of the invention, such references do not imply a limitation on the invention, and no such limitation is to be inferred. The invention is capable of considerable modification, alteration, and equivalents in form and function, as will occur to those ordinarily skilled in the pertinent arts. The depicted and described embodiments are examples only and are not exhaustive of the scope of the invention.

Consequently, the invention is intended to be limited only by the spirit and scope of the appended claims, giving full cognizance to equivalents in all respects.

What is claimed is:

1. A computer-implementable method for creating competency assessments and insights as to skills-profiles comprising:
providing multiple choices at a data source for an individual;
determining choices that are made as to possible options in a flow;
processing the options based on desirable skill sets of the flow; and
assessing competency level and skills profiles based on the processing of the options.

2. The computer-implementable method of claim 1, wherein the providing multiple choices is through human machine interaction.

3. The computer-implementable method of claim 1, wherein the data source is one of a video game, movie, or vehicle.

4. The computer-implementable method of claim 1, wherein the choices are presented in conflict situation in a configurable decision model.

5. The computer-implementable method of claim 1, wherein the processing the options determines if the individual demonstrates the desirable skill sets.

6. The computer-implementable method of claim 1, wherein the assessing includes determined competency level of the individual.

7. The computer-implementable method of claim 1, wherein the skill sets are desirable predetermined skills.

8. A system comprising:
a plurality of processing systems communicably coupled through a network, wherein the processing systems include non-transitory, computer-readable storage medium embodying computer program code interacting with a plurality of computer operations for creating competency assessments and insights as to skills-profiles comprising:
providing multiple choices at a data source for an individual;
determining choices that are made as to possible options in a flow;
processing the options based on desirable skill sets of the flow; and
assessing competency level and skills profiles based on the processing of the options.

9. The system of claim 8, wherein the providing multiple choices is through human machine interaction.

10. The system of claim 8, wherein the data source is one of a video game, movie, or vehicle.

11. The system of claim 8, wherein the choices are presented in conflict situation in a configurable decision model.

12. The system of claim 8, wherein the processing the options determine if the individual demonstrates the desirable skill sets.

13. The system of claim 8, wherein the assessing includes determined competency level of the individual.

14. The system of claim 8, wherein the skill sets are desirable predetermined skills.

15. A non-transitory, computer-readable storage medium embodying computer program code for creating competency assessments and insights as to skills-profiles, the computer program code comprising computer executable instructions configured for:
providing multiple choices at a data source for an individual;
determining choices that are made as to possible options in a flow;
processing the options based on desirable skill sets of the flow; and
assessing competency level and skills profiles based on the processing of the options.

16. The non-transitory, computer-readable storage medium of claim 15, wherein the providing multiple choices is through human machine interaction.

17. The non-transitory, computer-readable storage medium of claim 15, wherein the data source is one of a video game, movie, or vehicle.

18. The non-transitory, computer-readable storage medium of claim 15, wherein the choices are presented in conflict situation in a configurable decision model.

19. The non-transitory, computer-readable storage medium of claim 15, wherein the assessing includes determined competency level of the individual.

20. The non-transitory, computer-readable storage medium of claim 15, wherein the skill sets are desirable predetermined skills.
